(19) United States
(12) Patent Application Publication
(10) Pub. No.: US 2023/0148628 A1
(43) Pub. Date: May 18, 2023

(54) PLANT-BASED ANALOG MEAT COMPOSITIONS AND METHODS OF MANUFACTURE

(71) Applicant: CORN PRODUCTS DEVELOPMENT, INC, WESTCHESTER, IL (US)

(72) Inventors: Amy ALDERTON, Bridgewater, NJ (US); Ying BIAN, Bridgewater, NJ (US); Yadunandan DAR, Bridgewater, NJ (US); Nagul NAGULESWARAN, Bridgewater, NJ (US); Xin YANG, Bridgewater, NJ (US)

(21) Appl. No.: 17/916,072

(22) PCT Filed: Mar. 31, 2021
(86) PCT No.: PCT/US2021/025265

§ 371 Date: Sep. 30, 2022

Related U.S. Application Data
(60) Provisional application No. 63/004,429, filed on Apr. 2, 2020.

(51) Int. Cl. A23J 3/22; A23L 11/00; A23J 3/14

(52) U.S. Cl. CPC A23J 3/227; A23L 11/05; A23J 3/14

(57) ABSTRACT

The technology disclosed in this specification pertains to a plant-based meat analog comprising a pulse protein, and a vegetable oil. In any embodiment the pulse protein may be crosslinked. In any embodiment the oil may be provided as a structured vegetable oil comprising a vegetable oil and a water-soluble carrier. The plant-based meat analogs may further comprise moisture content of about 40% to about 65% by weight.

This specification discloses pulse protein compositions useful as meat alternatives or analog meat.

For economic and health reasons there is a desire among some to replace animal protein, including animal muscle protein, with plant proteins. But using plant protein to replace animal muscle protein specifically, and animal muscle meat more generally (which for simplicity is referred to herein as “meat”), poses various problems. For example, animal muscle proteins and plant proteins are conformationally different. Also, plant-based compositions, do not necessarily comprise fat, as is common in meat. Because of these differences plant-based meat analogs are texturally and functionally different than meat, and new methods and compositions are needed to make plant-based compositions more analogous to meat.

The technologies described in this specification are directed to improved compositions and methods for making plant-based compositions that are analogous to meat, which for simplicity are called herein “plant-based meat analogs.” In one aspect, the technology disclosed in this specification is directed to plant-based meat analogs comprising a vegetable oil loaded into a water-soluble carrier. In another aspect the technology disclosed in this specification is directed to plant-based meat analogs comprising at least one pulse protein that has been crosslinked using a protein crosslinking agent.

The technology disclosed in this specification is further described with reference to the attached figures, which are provided for illustrative purposes only and are not limiting in any way.

### BRIEF DESCRIPTION OF THE DRAWINGS

FIG. 1 depicts illustrative embodiments of uncooked plant-based meat analogs containing proteins crosslinked using one or more protein crosslinking agents.

FIG. 2 is a generic readout out from a texture analyzer, useful for illustrating concepts pertinent to embodiments of the meat analogs.

In one aspect the technology disclosed in this specification is directed to plant-based meat analogs comprising at least one pulse protein. In any embodiment, a plant-based meat analog described in this specification comprises a pulse protein. In any embodiment, a plant-based meat analog described in this specification comprises a pulse protein selected from the group consisting pea, chickpea, fava bean, lentil, lupin, kidney beans, black eyed peas, guar beans, hyacinth beans, lima beans, pinto beans, navy beans, black beans, and mung bean and mixtures thereof. In any embodiment, a plant-based meat analog described in this specification comprises a pulse protein selected from the group consisting of pea, chickpea, lentil, and fava bean and mixtures thereof. In any embodiment, a plant-based meat analog described in this specification comprises a pulse protein selected from the group consisting pea and fava bean and mixtures thereof. In any embodiment, a plant-based meat analog described in this specification comprises a pea protein. In any embodiment, a plant-based meat analog described in this specification comprises a fava bean protein.

In any embodiment, a plant-based meat analog as described in this specification comprises pulse protein obtained from a milled pulse or a milled and further processed pulse. In any embodiment, a plant-based meat analog as described in this specification comprises a milled pulse composition, which are commonly called pulse flours, for example a pea flour, a chickpea a flour, a fava bean flour, or a lentil flour. In any embodiment, a plant-based meat analog as described in this specification comprises a milled and further processed pulse, such compositions may be referred to as a pulse protein concentrate or a pulse protein isolate, or a textured vegetable protein. In any embodiment, a plant-based meat analog as described in this specification comprises a protein concentrate, for example pea protein concentrate, chickpea protein concentrate, fava bean protein concentrate, or lentil protein concentrate. In any embodiment, a plant-based meat analog as described in this specification comprises a protein isolate, for example a pea protein isolate, a chickpea protein isolate, a fava bean protein isolate, or a lentil protein isolate. In any embodiment, a plant-based meat analog as described in this specification comprises a mixture of a pulse protein concentrate and a pulse protein isolate.

In any embodiment, a plant-based meat analog as described in this specification comprises one or more of a pulse flour, a pulse protein isolate, or a pulse protein concentrate, optionally wherein the pulse is selected from pea, chickpea, fava bean, lentil, lupin, kidney beans, black eyed peas, guar beans, hyacinth beans, lima beans, pinto beans, navy beans, black beans, and mung bean and mixtures thereof, more preferably from a pea, lentil, chickpea or fava bean. In any embodiment, a plant-based meat analog as described in this specification comprises one or more of a pea protein isolate, a pea protein concentrate, a fava bean protein concentrate, a fava bean protein isolate, and mixtures thereof.

For illustrative purposes without intending to bound by exact protein content requirements, pulse flours, pulse protein concentrates, and pulse protein isolates vary, among other reasons, in their relative amounts of protein and starch content. Pulse flours are milled compositions that comprise the components of the whole pulse in roughly the same proportions. Pulse flours commonly have between 25% and 50% protein by weight, with remainder being mostly starch although fiber content may be as much as about 10%. Pulse protein concentrates are typically air classified powdered compositions. Air classification removes some portion of the starch and thereby increase the relative protein content in the powder. Pulse protein concentrates commonly have from about 50% to about 75% protein by weight, although most commonly have protein content in the range of 60% to 70% protein by weight. Pulse protein isolates are also powdered compositions but are commonly obtained using wet filteration for example relying on the different solubilities of starch and protein at various pH. Pulse proteins generally have greater than 75% by weight, most commonly between 80% and 90% protein by weight, although the highest possible protein content is desired.

In any embodiment, a plant-based meat analog as described in this specification comprises a pulse protein in an amount between about 50% and about 90% protein (by weight of the analog), or between about 55% and about 90% protein, or between about 60% and about 90% protein, or between about 65% and about 90% protein, or between about 70% and about 90% protein, or between about 50% and about 85% protein, or between about 50% and about 80%, or between about 50% and about 75% or between about 50% and about 70%, or between 50% and 65% protein. In any embodiment, a plant-based meat analog as described in this specification comprises a pulse protein in an amount of between about 55% and about 65% protein (by weight of the analog). In any embodiment, a plant-based meat analog as described in this specification comprises a pulse protein in an amount of comprising between 65% and about 85% protein (by weight of the analog). In any embodiment, a plant-based meat analog as described in this specification comprises a pulse protein in an amount between about 65% and about 75% protein (by weight of the analog). In embodiments a plant-based meat analog comprises a pulse protein in an amount between about 75% and about 85% protein (by weight of the analog).

In any embodiment, the protein content in a plant-based meat analog, may come from one or more pulse sources or from a mixture of a pulse flour, pulse protein concentrate or pulse protein isolate obtained from the same or different pulse source.

In any embodiment, a plant-based meat analog as described in this specification comprises starch. In any embodiment, a plant-based meat analog as described in this specification comprises a starch from the same botanical source as the protein. In any embodiment, a plant-based meat analog as described in this specification comprises a starch from a different botanical source as the protein. In any embodiment, a plant-based meat analog as described in this specification comprises starch provided by a pulse flour, pulse protein concentrate, or pulse protein isolate. In any embodiment, a plant-based meat analog as described in this specification comprises a pea starch, a chickpea starch, a fava bean starch, a lentil starch or corn starch, or tapioca starch or potato starch and high amylose or low amylose variants of the following and mixtures thereof. In any embodiment, a plant-based meat analog as described in this specification comprises starch in an amount of between about 0.5% and about 20% (by weight of the analog), or between about 0.5% and about 15%, or between about 0.5% and about 10%, or between about 1% and about 10%, or between about 4% and about 10% starch, or between about 5% and about 10% starch, or between about 6% and about 10% starch, or between about 7% and about 10% starch.

In any embodiment, a plant-based meat analog as described in this specification comprises a second starch, which may be a native starch or a modified starch or a gelatinized starch. In any embodiment, a plant-based meat analog as described in this specification comprises a second starch, which is used a co-texturizer or a texturizer, including to provide gel strength to a plant-based meat analog, or as a stabilizer or emulsifier. Modified starches useful in any embodiment of a plant-based meat analog described in this specification include, reduced molecular weight starches, converted starches, acid or enzymatically hydrolyzed starches, shear converted starches, oxidized starches, stabilized starch (such as by acetyl or hydroxypropyl stabilization), or inhibited starch such as thermally inhibited starches or chemically crosslinked starches such as adipate crosslinked starches or phosphate crosslinked starches, or succinate derivatized starches such as octenyl-succinic acid derivatized starches.

In any embodiment, a plant-based meat analog as described in this specification comprises a pulse protein having one or more of high soluble content, high dispersion stability, high water holding capacity. In any embodiment, a plant-based meat analog as described in this specification comprises a pulse protein capable of forming a firm gel.

In any embodiment, a plant-based meat analog as described in this specification comprises a pulse protein wherein the weight fraction of the protein content in the composition that is soluble at 25° C. is between about 50% and about 80% (by weight), or between about 60% and about 80% or between about 65% and about 80%, or between about 70% and about 80%, or between about 71% and about 79%, or between about 72% and about 78% or between about 73% and about 77%.

In any embodiment described in this specification, protein solubility is measured by determining the difference between the total protein and measured insoluble protein content in a sample, using centrifuge (e.g. from Beckman Coulter) and LECO protein analyzer using the following process: Add protein powder (1% w/w, dry protein basis) to buffered or deionized water while stirring at room temperature for 60 minutes. Transfer and centrifuge at 4000 g for 10 min at room temperature. Separate supernatant and precipitate (wet residue) and measure the protein content of wet residue with the LECO protein analyzer, protein factor: N×6.25.

In any embodiment, a plant-based meat analog as described in this specification comprises a pulse protein wherein a significant amount of the insoluble protein is capable of being stably dispersed in 25° C. water for at least 1 hour, which for simplicity is called the “percent dispersion stability” within this specification. In any embodiment, a plant-based meat analog as described in this specification comprises a pulse protein having a percent dispersibility of between about 40% and about 70% (by weight), or between about 50% and about 70%, or between about 60% and about 70% or between about 61% and about 79% or between about 62% and about 68%, or between about 63% and about 67%.

In any embodiment, a plant-based meat analog as described in this specification comprises a pulse protein having water holding capacity of between about 0.5 and about 1.5 (w/w, protein to water), or between about 0.6 and about 1.5, or between about 0.5 and about 1.4, or between about 0.5 and about 1.3 or between about 0.5 and about 1.2, or between about 0.6 and about 0.13 or between about 0.7 and about 1.2. In any embodiment, a plant-based meat analog as described in this specification comprises a pulse protein capable of holding between about 50% and about 150% of its weight in water (w/w, protein to water), or between about 50% and about 140%, or between about 50% and about 130%, or between about 50% and about 120%, or between about 60% and about 150%, or between about 60% and about 130%, or between about 70% and about 120%, or between about 80% and about 110%, or between 95% and 105%. In any embodiment, a plant-based meat analog as described in this specification comprises a pulse protein capable of forming a gel (15% solids in water, at 25° C.) having a punch force between 4 g and 10 g, or between 4 g and 9 g, or between 4 g and 8 g, or between 5 g and 10 g, or between 5 g and 9 g, or between 6 g and 10 g, or between 6 g and 9 g, or about 7 g.

In any embodiment, a plant-based meat analog as described in this specification further comprises a structured plant or vegetable oil, which for simplicity in this specification are referred to collectively as a “structured vegetable oil.” Within this specification structured vegetable oil refers to oil that has been loaded into a carrier system so that at least some of the oil is absorbed into the carrier system. In any embodiment of a plant-based meat analog described in this specification, a structured vegetable oil is obtained by loading an oil into a water-soluble carrier system. In any embodiment of a plant-based meat analog described in this specification, a structured vegetable oil is obtained by loading a vegetable oil into a tapioca maltodextrin. In any embodiment, a structured oil useful in a plant-based meat analog described in this specification comprises a water-soluble carrier within a continuous oil phase. In any embodiment, a plant-based meat analog as described in this specification further comprises a structured vegetable oil in the form of a paste.

In any embodiment, a plant-based meat analog as described in this specification further comprises a structured vegetable oil comprised of a plant or vegetable oil and a water soluble carrier in ratio of greater than 3:1 (oil to carrier), greater than 10:1, or from about 4:1 to about 15:1, or from about 7:1 to about 15:1, or from about 8:1 to about 15:1, or from about 9:1 to about 15:1, or from about 10:1 to about 15:1, or from about 10:1 to about 14:1, or from about 11:1 to about 13:1, or from about 4:1 to about 9:1, or from about 4:1 to about 6:1.

In any embodiment, a plant-based meat analog as described in this specification further comprises a plant or vegetable oil. In any embodiment of a plant-based meat analog as described in this specification, all vegetable oil in the plant-based meat analog is loaded into a water-soluble carrier. In any embodiment of a plant-based meat analog as described in this specification a portion of the plant or vegetable oil in the plant-based meat analog is loaded into a water-soluble carrier. In any embodiment, a plant-based meat analog as described in this specification further comprises a liquid oil loaded onto a carrier to make a paste. In any embodiment, a plant-based meat analog as described in this specification further comprises a vegetable or plant oil in an amount of from about 5% to about 30%, or from about 5% to about 25%, or from about 5% to about 20% (by weight of the analog), or from about 10% to about 20%, or from about 12% to about 18%, or from about 14% to about 16%. In any embodiment, a plant-based meat analog as described in this specification further comprises or a sunflower oil, or corn oil or canola oil, or olive oil, or other liquid vegetable oil, or mixtures thereof. In any embodiment, a plant-based meat analog as described in this specification further comprises one or more vegetable or plant oils that is liquid at room temperature (about 23° C.).

In any embodiment, a plant-based meat analog as described in this specification further comprises a second vegetable oil, which is typically vegetable oil that is solid at around room temperature. In any embodiment, a plant-based meat analog as described in this specification includes a palm oil or a coconut oil.

In any embodiment of a plant-based meat analog as described in this specification a portion of the vegetable oil in the plant-based meat analog is a structured vegetable oil. In any embodiment, a plant-based meat analog as described in this specification further comprises a first and a second oil wherein the second oil is a structured vegetable oil and makes up from about 4% to about 12%, or from about 4% to about 9%, or from about 4% to about 6% of the plant-based meat analog.

In any embodiment of a plant-based meat analog as described in this specification a portion of the vegetable oil in the plant-based meat analog is not a structured vegetable oil. In any embodiment, a plant-based meat analog as described in this specification further comprises a first and a second oil wherein the second oil is not a structured oil and makes up from about 4% to about 9%, or from about 4% to about 6% of the plant-based meat analog.

In any embodiment, a plant-based meat analog as described in this specification further comprises a water-soluble carrier in an amount of from about 0.1 to about 2% (by weight of the analog), or from about 0.5% to about 1.5% or from about 0.75% to about 1.25%.

In any embodiment a plant-based meat analog as described in this specification comprises moisture in an amount of from about 40% to about 65% by weight or from about 40% to about 60% or from about 50% to about 60%.

In any embodiment, a plant-based meat analog as described in this specification is cooked and during cooking releases some of the oil in the structured vegetable oil system to replicate the effects of animal fat melting when meat is cooked, for example including but not limited to a sizzling noise. In any embodiment, a plant-based meat analog as disclosed in this specification releases oil during cooking but retains enough oil such that after cooking the cooked plant-based meat analog comprises a fatty mouthfeel when eaten.

In any embodiment, a plant-based meat analog as described in this specification comprises a crosslinked pulse protein. In any embodiment, a plant-based meat analog as described in this specification comprises a crosslinked pulse protein wherein the pulse protein has been crosslinked using a protein crosslinking agent useful for crosslinking amino acids in a protein. In any embodiment, a plant-based meat analog as described in this specification comprises a crosslinked pulse protein wherein the pulse protein has been crosslinked using one or more of a transglutaminase and L-cysteine.

In any embodiment, crosslinked pulse proteins useful in a plant-based meat analog, as described in this specification, can be made by a method comprising mixing a pulse protein and a protein crosslinking agent in an excess of water or aqueous solution, such that the plant-based protein and protein crosslinking agent are dispersed within the water, and a crosslinked pulse protein composition is recovered from the dispersion using known dewatering methods. In any embodiment, crosslinked pulse proteins useful in a plant-based meat analog, as described in this specification, can be made by a method comprising mixing a pulse protein and a protein crosslinking agent in a dough-based system such that the plant-based protein and protein crosslinking agent absorb all liquid present.

In any embodiment, crosslinked pulse proteins useful in a plant-based meat analog, as described in this specification, can be made according to a method comprising mixing a pulse protein with transglutaminase in water or aqueous solution in a ratio (pulse protein and protein crosslinking agent to water) of between about 1:2 and about 1:9, between about 1:2 and about 1:7, or between about 1:2 and about 1:6, or between about 1:4 and 1:6, or between about 1:4 and about 1:9. In any embodiment, crosslinked pulse proteins useful in a plant-based meat analog, as described in this specification, can be made according to a method comprising mixing a pulse protein and transglutaminase in a ratio of between 4:1 and 19:1 (pulse protein to enzyme), or between 4:1 and 14:1, or between 4:1 and 9:1 or between 9:1 and 19:1, or between 14:1 and 19:1. In any embodiment, crosslinked pulse proteins useful in a plant-based meat analog, as described in this specification, can be made according to a method comprising mixing for between about 30 and 120 minutes. In any embodiment, pulse protein and transglutaminase are mixed in a solution having pH between 4.0 and 5.5.

In any embodiment, crosslinked pulse proteins useful in a plant-based meat analog, as described in this specification, can be made according to a method comprising mixing pulse protein with L-cysteine in a weight ratio (pulse protein to L-cysteine) of between about 1:149 and about 1:49, or between about 1:119 and about 1:49, or between about 1:109 and about 1:49, or between about 1:104 and about 1:94. In any embodiment, crosslinked pulse proteins useful in a plant-based meat analog, as described in this specification, can be made according to a method comprising mixing pulse protein, L-cysteine and water in in a ratio of between about 1:1 to about 9:1 (L-cysteine and pulse protein to water), or between about 5:1 and about 9:1, or between about 7:1 and about 9:1, or between about 1:1 and about 4:1, between about 1:1 and about 2:1.

In any embodiment, a plant-based meat analog described in this specification made using crosslinked plant-based proteins is a less sticky more firm dough. In any embodiment, a plant-based meat analog described in this specification made using a crosslinked pulse protein, when cooked, has good firmness and resilience with limited stickiness.

In any embodiment, firmness and resilience can be measured using Texture Profile Analysis (TPA) performed using a TAXT Plus texture analyzer to determine resilience, compression force, and cohesiveness. The Texture Profile Analysis (TPA) of a plant-based meat analog was determined using a TAXT Plus texture analyzer.

In any embodiment, a plant-based meat analog as described specification has a peak compression force of between 8,000 g and 12,000 g, or between 8,000 g and 11,500 g, or between 8,000 g and 11,000 g, or between 8,000 g and 10,500 g, or between 8,500 g, and 10,500 g, or between 8,000 g and 10,500 g, or between 7,500 g and 10,500 g, or between 7,000 g and 10,500 g.

In any embodiment, a plant-based meat analog as described specification has a cohesiveness of between 0.5 and 0.9, or 0.5 and 0.8, or between 0.5 and 0.7 or between 0.9 and 0.6, or between 0.7 and 0.9.

In any embodiment, a plant-based meat analog as described specification has a resilience of between 0.2 and 0.5, or between 0.2 and 0.4 or between 0.3 and 0.5 or between 0.3 and 0.4.

In any embodiment, a plant-based meat analog as described in this specification forms a dough or dough like composition that may cooked in any convention manner, for example steaming, baking, or boiling. In any embodiment, a plant-based meat analog as described in this specification forms a dough that is cooked in an extrusion process. In any embodiment a plant-based meat analog the complete dough is fed into an extruder. In another embodiments the pulse protein composition, protein crosslinking agent, and water may be added separately or in combination to the extruder, which forms and cooks the dough.

In any embodiment of a plant-based meat analog described in this specification, a dough may be formed by adding moisture to a powdered pulse protein, for example one or more of a pulse flour, pulse protein concentrate, or pulse protein isolate, and optionally at least a second ingredient. In any embodiment of a plant-based meat analog described in this specification, a dough is formed by adding only such much moisture as can be absorbed by a powdered pulse protein composition. In any embodiment, of a plant-based meat analog described in this specification, is formed by adding enough water to disperse a pulse protein composition within the water, wherein at least a portion of the pulse protein composition dissolved in the water. In such embodiments the pulse protein composition may be recovered from a supernatant (which has been separated from the rest of the dispersion) as a single-phase system where all water is absorbed in by the recovered material. Such recovered material may be called a cake or a dough. Dissolved solids may be recovered from the supernatant of the dispersion by known means, such as adjusting the pH of the supernatant.

In any embodiment, a plant-based meat analog as described in this specification may further include any other ingredient commonly used in meat analogs. Such ingredients include flavorings, seasoning, colorings, salts, and native, pregelatinized and modified starches, and gums and other hydrocolloids.

In any embodiment, a plant-based meat analog described in this specification can be formed into any desired shape. In any embodiment, a plant-based meat analog described in this specification does not comprise animal protein. In any embodiment, a plant-based meat analog described in this specification does not comprise any animal product or by product. In any embodiment, a plant-based meat analog described in this specification is a vegan composition.

Also disclosed in this specification are methods of making a plant-based meat analog. In any method for making a plant-based meat analog described in this specification comprises mixing a pulse protein and water to form a first mixture and adding to the mixture a structured vegetable oil to form the plant-based meat analog. In any method for making a plant-based meat analog described in this specification comprises mixing a pulse protein, a crosslinker and water to form a first mixture and adding to the mixture a structured vegetable oil to form the plant-based meat analog. In any embodiment, a method for making a plant-based meat analog further comprises adding one or more of a flavoring, a seasoning, a coloring, a salt, and a gum or other hydrocolloid to a pulse protein or mixture of one or more of pulse protein, water protein crosslinking agent, and structured vegetable oil.

Reference in this specification to a “pulse” means the seed from a legume plant, which are commonly associated with the family leguminosae orfabaceae.

Reference in this specification to a “pulse protein” means protein obtained from a pulse.

Reference in this specification to “structured vegetable oil” means a vegetable oil that has been loaded into a carrier system so that at least some of the oil is absorbed into the carrier system.

Reference in this specification to “vegetable oil” means oil from a plant source regardless whether the source is strictly thought of like as vegetable for example, by way of illustration but not limitation, sunflower oil is vegetable oil because it comes from a plant source (a sunflower).

Reference in this specification to “transglutaminase” means any one of a class of enzymes capable of catalyzing the formation of an isopeptide bond between γ-carboxamide groups of glutamine residue side chains and ε-amino groups of lysin residue side chains.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described by the following aspects, which are provided for illustrative purposes only and are not limiting in any way.

In a first aspect, the technology disclosed in this specification pertains to a plant-based meat analog comprising: a pulse protein; a structured vegetable oil comprising a vegetable oil and a water-soluble carrier; and moisture in an amount of from about 40% to about 65% by weight or from about 40% to about 60% or from about 50% to about 60%.

In a second aspect, the technology disclosed in this specification pertains to the plant-based meat analog as described in the first aspect wherein the pulse protein is selected from the group consisting of pea, chickpea, fava bean, lentil, lupin, kidney beans, black eyed peas, guar beans, hyacinth beans, lima beans, pinto beans, navy beans, black beans, and mung bean and mixtures thereof; wherein optionally preferably the pulse protein is selected from the group consisting of pea, chickpea, lentil, and fava bean and mixtures thereof, wherein optionally the pulse protein is one more of a pea protein and a fava bean protein.

In a third aspect, the technology disclosed in this specification pertains to the plant-based meat analog as described in the first or second aspects having a protein in an amount between about 50% and about 90% protein (by weight of the analog), or between about 55% and about 90% protein, or between about 60% and about 90% protein, or between about 65% and about 90% protein, or between about 70% and about 90% protein, or between about 50% and about 85% protein, or between about 50% and about 80%, or between about 50% and about 75% or between about 50% and about 70%, or between 50% and 65% wherein optionally, the protein content is between about 55% and about 65% protein (by weight of the analog) or between about 65% and about 75% protein (by weight of the analog).

In a fourth aspect, the technology disclosed in this specification pertains to the plant-based meat analog as described in any one of the first to third aspects further comprising a starch in an amount of between about 1% and about 20% (by weight of the analog), or between about 1% and about 15%, or between about 1% and about 10%, or between about 4% and about 10% starch, or between about 5% and about 10% starch, or between about 6% and about 10% starch, or between about 7% and about 10% starch.

In a fifth aspect, the technology disclosed in this specification pertains to the plant-based meat analog as described in any one of the first to fourth aspects wherein the pulse protein has a percent that is soluble at 25° C. between about 50% and about 80% (by weight), or between about 60% and about 80% or between about 65% and about 80%, or between about 70% and about 80%, or between about 71% and about 79%, or between about 72% and about 78% or between about 73% and about 77%.

In a sixth aspect, the technology disclosed in this specification pertains to the plant-based meat analog as described in any one of the first to fifth aspects, wherein the pulse protein has a percent of the insoluble protein that is capable of being stably dispersed in 25° C. water for at least 1 hour of between about 40% and about 70% (by weight), or between about 50% and about 70%, or between about 60% and about 70% or between about 61% and about 79% or between about 62% and about 68%, or between about 63% and about 67%.

In a seventh aspect, the technology disclosed in this specification pertains to the plant-based meat analog as described in any one of the first to sixth aspects wherein the pulse protein has a water holding capacity of between about 0.5 and about 1.5 (w/w, protein to water), or between about 0.6 and about 1.5, or between about 0.5 and about 1.4, or between about 0.5 and about 1.3 or between about 0.5 and about 1.2, or between about 0.6 and about 0.13 or between about 0.7 and about 1.2.

In an eighth aspect, the technology disclosed in this specification pertains to the plant-based meat analog as described in any one of the first to seventh aspects, wherein the pulse protein is capable of holding between about 50% and about 150% of its weight in water (w/w, protein to water), or between about 50% and about 140%, or between about 50% and about 130%, or between about 50% and about 120%, or between about 60% and about 130%, or between about 60% and about 150%, or between about 70% and about 120%, or between about 80% and about 110%, or between 95% and 105%.

In a ninth aspect, the technology disclosed in this specification pertains to the plant-based meat analog as described in any one of the first to eighth aspects wherein the pulse protein is capable of forming a gel (15% solids in water, at 25° C.) having a punch force between 4 g and 10 g, or between 4 g and 9 g, or between 4 g and 8 g, or between 5 g and 10 g, or between 6 g and 10 g, or between 5 g and 9 g, or between 6 g and 9 g, or about 7 g.

In a tenth aspect, the technology disclosed in this specification pertains to the plant-based meat analog as described in any one of the first to ninth aspects, wherein the water-soluble carrier is a tapioca maltodextrin.

In an eleventh aspect, the technology disclosed in this specification pertains to the plant-based meat analog as described in any one of the first to tenth aspects wherein the structure oil has an oil-to-water soluble carrier ratio of greater than 3:1 (oil to carrier), greater than 10:1, or from about 4:1 to about 15:1, or from about 7:1 to about 15:1, or from about 8:1 to about 15:1, or from about 9:1 to about 15:1, or from about 10:1 to about 15:1, or from about 10:1 to about 14:1, or from about 11:1 to about 13:1, or from about 4:1 to about 9:1, or from about 4:1 to about 6:1.

In a twelfth aspect, the technology disclosed in this specification pertains to the plant-based meat analog as described in any one of the first to eleventh aspects wherein the vegetable oil is used in an amount of from about 5% to about 20% (by weight of the analog), or from about 10% to about 20%, or from about 12% to about 18%, or from about 14% to about 16% wherein optionally the total vegetable oil is provided by a first and a second vegetable oil.

In a thirteenth aspect, the technology disclosed in this specification pertains to the plant-based meat analog as described in any one of the first to twelfth aspect, further comprising a second vegetable oil, which is not a structured vegetable oil, in an amount of from 4% to about 9%, or from about 4% to about 6%.

In a fourteenth aspect, the technology disclosed in this specification pertains to the plant-based meat analog as described in any one of the first to thirteenth aspects wherein the water-soluble carrier is used in an amount of from about 0.1 to about 2% (by weight of the analog), or from about 0.5% to about 1.5% or from about 0.75% to about 1.25%.

In a fifteenth aspect, the technology disclosed in this specification pertains to the plant-based meat analog as described in any one of the first to fourteenth aspects further comprising a crosslinked pulse protein, wherein optionally the plant-based meat analog further comprises a protein crosslinking agent; wherein optionally, the plant-based meat analog wherein the protein crosslinking agent is selected from the group consisting of a transglutaminase and L-cysteine and mixtures thereof.

In a sixteenth aspect, the technology disclosed in this specification pertains to the plant-based meat analog as described in any one of the first to fifteenth aspects further comprising a crosslinked pulse protein wherein the crosslinked pulse protein is made in a process comprising mixing transglutaminase, water and pulse protein in a ratio (protein and crosslinking agent to water) of about 1:2 and about 1:9, about 1:2 and about 1:7, or between about 1:2 and about 1:6, or between about 1:4 and 1:6, or between about 1:4 and about 1:9.

In a seventeenth aspect, the technology disclosed in this specification pertains to the plant-based meat analog as described in any one of the first to sixteenth aspects further comprising a crosslinked pulse protein wherein the crosslinked pulse protein is made in a process comprising mixing L-cysteine and pulse protein in a weight ratio (pulse protein to L-cysteine) of between about 1:149 and about 1:49, or between about 1:119 and about 1:49, or between about 1:109 and about 1:49, or between about 1:104 and about 1:94.

In an eighteenth aspect, the technology disclosed in this specification pertains to the plant-based meat analog as described in any one of the first to seventeenth aspects having a peak compression force when cooked, of between 8,000 g and 12,000 g, or between 8,000 g and 11,500 g or between 8,000 g and 11,000 g or between 8,000 g and 10,500 g or between 8,500 g, and 10,500 g, or between 8,000 g and 10,500 g and, or between 7,500 g and 10,500 g or between 7,000 g and 10,500 g;

In a nineteenth aspect, the technology disclosed in this specification pertains to the plant-based meat analog as described in any one of the first to eighteenth aspects having a cohesiveness of the cooked plant-based meat analog of between 0.5 and 0.9, or 0.5 and 0.8, or between 0.5 and 0.7 or between 0.9 and 0.6, or between 0.7 and 0.9.

In a twentieth aspect, the technology disclosed in this specification pertains to the plant-based meat analog as described in any one of the first to twentieth aspects having a resilience of the cooked plant-based meat analog of between 0.2 and 0.5, or between 0.2 and 0.4 or between 0.3 and 0.5 or between 0.3 and 0.4.

In a twenty-first aspect, the technology disclosed in this specification pertains to a plant-based meat analog comprising: a crosslinked pulse protein and a starch; optionally wherein the pulse protein is crosslinked using a protein crosslinking agent selected from the group consisting of a transglutaminase and L-cysteine and mixtures thereof.

In a twenty-second aspect, the technology disclosed in this specification pertains to the plant-based meat analog as described in the twenty-first aspect further comprising a starch in an amount between about 1% and about 20% (by weight of the analog), or between about 1% and about 15%, or between about 1% and about 10%, or between about 4% and about 10% starch, or between about 5% and about 10% starch, or between about 6% and about 10% starch, or between about 7% and about 10% starch.

In a twenty-third aspect, the technology disclosed in this specification pertains to the plant-based meat analog as described in the twenty-first or twenty-second aspects wherein the starch is from the same botanical source as the protein.

In a twenty-fourth aspect, the technology disclosed in this specification pertains to the plant-based meat analog as described in any one of the twenty-first to twenty-third aspects wherein the pulse protein is selected from the group consisting of pea, chickpea, fava bean, lentil, lupin, kidney beans, black eyed peas, guar beans, hyacinth beans, lima beans, pinto beans, navy beans, black beans, and mung bean and mixtures thereof; wherein optionally preferably the pulse protein is selected from the group consisting of pea, chickpea, lentil, and fava bean and mixtures thereof, wherein optionally the pulse protein is one more of a pea protein and a fava bean protein.

In a twenty-fifth aspect, the technology disclosed in this specification pertains to the plant-based meat analog as described in any one of the twenty-first to twenty-fourth aspects having a protein in an amount between about 50% and about 90% protein (by weight of the analog), or between about 55% and about 90% protein, or between about 60% and about 90% protein, or between about 65% and about 90% protein, or between about 70% and about 90% protein, or between about 50% and about 85% protein, or between about 50% and about 80%, or between about 50% and about 75% or between about 50% and about 70%, or between 50% and 65% wherein optionally, the protein content is between about 55% and about 65% protein (by weight of the analog) or between about 65% and about 75% protein (by weight of the analog).

In a twenty-sixth aspect, the technology disclosed in this specification pertains to the plant-based meat analog as described in any one of the twenty-first to twenty-fifth aspects wherein the pulse protein has a percent that is soluble at 25° C. between about 50% and about 80% (by weight), or between about 60% and about 80% or between about 65% and about 80%, or between about 70% and about 80%, or between about 71% and about 79%, or between about 72% and about 78% or between about 73% and about 77%.

In a twenty-seventh aspect, the technology disclosed in this specification pertains to the plant-based meat analog as described in any one of the twenty-first to twenty-sixth aspects wherein the pulse protein has a percent of the insoluble protein that is capable of being stably dispersed in 25° C. water for at least 1 hour of between about 40% and about 70% (by weight), or between about 50% and about 70%, or between about 60% and about 70%, or between about 61% and about 79%, or between about 62% and about 68%, or between about 63% and about 67%.

In a twenty-eighth aspect, the technology disclosed in this specification pertains to the plant-based meat analog as described in any one of the twenty-first to twenty-seventh aspect, wherein the pulse protein has a water holding capacity of between about 0.5 and about 1.5 (w/w, protein to water), or between about 0.6 and about 1.5, or between about 0.5 and about 1.4, or between about 0.5 and about 1.3 or between about 0.5 and about 1.2, or between about 0.6 and about 0.13 or between about 0.7 and about 1.2.

In a twenty-ninth aspect, the technology disclosed in this specification pertains to the plant-based meat analog as described in any one of the twenty-first to twenty-eighth aspects wherein the pulse protein is capable of holding between about 50% and about 150% of its weight in water (w/w, protein to water), or between about 50% and about 140%, or between about 50% and about 130%, or between about 50% and about 120%, or between about 60% and about 130%, or between about 60% and about 150%, or between about 70% and about 120%, or between about 80% and about 110%, or between 95% and 105%.

In a thirtieth aspect, the technology disclosed in this specification pertains to the plant-based meat analog as described in any one of the twenty-first to twenty-ninth aspects wherein the pulse protein is capable of forming a gel (15% solids in water, at 25° C.) having a punch force between 4 g and 10 g, or between 4 g and 9 g, or between 4 g and 8 g, or between 5 g and 10 g, or between 6 g and 10 g, or between 5 g and 9 g, or between 6 g and 9 g, or about 7 g.

In a thirty-first aspect, the technology disclosed in this specification pertains to the plant-based meat analog as described in any one of the twenty-first to thirtieth aspects further comprising a structured vegetable comprising a water-soluble carrier and a vegetable oil optionally wherein the water-soluble carrier is a tapioca maltodextrin.

In a thirty-second aspect, the technology disclosed in this specification pertains to the plant-based meat analog as described in any one of the of the twenty-first to thirty-first aspects wherein the vegetable oil and a water-soluble carrier are used in a ratio, oil-to-water-soluble carrier, of greater than 3:1 (oil to carrier), greater than 10:1, or from about 4:1 to about 15:1, or from about 7:1 to about 15:1, or from about 8:1 to about 15:1, or from about 9:1 to about 15:1, or from about 10:1 to about 15:1, or from about 10:1 to about 14:1, or from about 11:1 to about 13:1, or from about 4:1 to about 9:1, or from about 4:1 to about 6:1.

In a thirty-third aspect, the technology disclosed in this specification pertains to the plant-based meat analog as described in any one of the twenty-first to thirty-second aspects wherein the vegetable oil in an amount of from about 5% to about 20% (by weight of the analog), or from about 10% to about 20%, or from about 12% to about 18%, or from about 14% to about 16%; wherein optionally the vegetable oil is provided by first and a second vegetable oil, and wherein the second vegetable oil is used in an amount of from 4% to about 9%, or from about 4% to about 6%; and wherein optionally the second vegetable oil is not a structured vegetable oil.

In a thirty-fourth aspect, the technology disclosed in this specification pertains to the plant-based meat analog as described in any one of the twenty-first to thirty-third aspect, wherein the water-soluble carrier is used in an amount of from about 0.1 to about 2% (by weight of the analog), or from about 0.5% to about 1.5% or from about 0.75% to about 1.25%.

In a thirty-fifth aspect, the technology disclosed in this specification pertains to the plant-based meat analog as described in any one of the twenty-first to thirty-fourth aspects further comprising a crosslinked pulse protein wherein crosslinked pulse protein is crosslinked in a process comprising mixing a transglutaminase, pulse protein and water in a ratio (pulse protein and crosslinking agent to water) of between about 1:2 and about 1:9, or between about 1:2 and about 1:7, or between about 1:2 and about 1:6, or between about 1:4 and 1:6, or between about 1:4 and about 1:9.

In a thirty-sixth aspect, the technology disclosed in this specification pertains to the plant-based meat analog of any one of the twenty-first to thirty-fifth aspects further comprising a crosslinked pulse protein wherein the pulse protein is crosslinked in a process comprising mixing L-cysteine and pulse protein in a weight ratio (pulse protein composition to L-cysteine) of between about 1:149 and about 1:49, or between about 1:119 and about 1:49, or between about 1:109 and about 1:49, or between about 1:104 and about 1:94.

In a thirty-seventh aspect, the technology disclosed in this specification pertains to the plant-based meat analog of any one of the twenty-first to thirty-sixth aspects having a peak compression force when cooked, of between 8,000 g and 12,000 g, or between 8,000 g and 11,500 g or between 8,000 g and 11,000 g or between 8,000 g and 10,500 g or between 8,500 g, and 10,500 g, or between 8,000 g and 10,500 g and, or between 7,500 g and 10,500 g or between 7,000 g and 10,500 g.

In a thirty-eighth aspect, the technology disclosed in this specification pertains to the plant-based meat analog of any one of the twenty-first to thirty-seventh aspects having a cohesiveness of the cooked plant-based meat analog of between 0.5 and 0.9, or 0.5 and 0.8, or between 0.5 and 0.7 or between 0.9 and 0.6, or between 0.7 and 0.9.

In a thirty-ninth aspect, the technology disclosed in this specification pertains to the plant-based meat analog of any one of the twenty-first to thirty-eighth aspects having a resilience of the cooked plant-based meat analog of between 0.2 and 0.5, or between 0.2 and 0.4 or between 0.3 and 0.5 or between 0.3 and 0.4.

In a fortieth aspect, the technology disclosed in this specification pertain to a method for making a plant-based meat analog as described in any foregoing claim comprising mixing a pulse protein and water to form a first mixture wherein optionally the method further comprises crosslinking the pulse protein using a protein crosslinking agent, wherein optionally the pulse protein is crosslinked in a solution having pH of from about 4.0 to about 4.5, wherein in optionally the method further comprises adding a structured vegetable oil to the first mixture.

In a forty-first aspect, the technology disclosed in this specification pertain to the method for making a plant-based meat analog the fortieth aspect wherein the protein crosslinking agent is selected from the group consisting of transglutaminase and L-cysteine.

In a forty-second aspect, the technology disclosed in this specification pertains to the method the fortieth or forty-first aspects wherein the structured vegetable oil comprises a vegetable oil and a water-soluble carrier wherein optionally the water-soluble carrier is a tapioca maltodextrin.

In a forty-third aspect, the technology disclosed in this specification pertains to the method described in any one of the fortieth to forty-second aspect wherein the pulse protein is mixed with transglutaminase and water in a ratio (pulse protein and crosslinking agent to water) of about 1:2 and about 1:9, about 1:2 and about 1:7, or between about 1:2 and about 1:6, or between about 1:4 and 1:6, or between about 1:4 and about 1:9.

In a forty-fourth aspect, the technology disclosed in this specification pertains to the method described in any one of the fortieth to forty-third aspects wherein L-cysteine is mixed pulse protein in a weight ratio (pulse protein composition to L-cysteine) of between about 1:149 and about 1:49, or between about 1:119 and about 1:49, or between about 1:109 and about 1:49, or between about 1:104 and about 1:94.

In a forty-fifth aspect, the technology disclosed in this specification pertains to the method described in any one of the fortieth to forty-forth aspects, further comprising forming a structured vegetable oil comprising mixing a vegetable oil with a water-soluble carrier; wherein optionally the water-soluble carrier is a tapioca maltodextrin.

In a forty-sixth aspect, the technology disclosed in this specification pertains to a cooked plant-based meat analog comprising a pulse protein and a vegetable oil.

In a forty-seventh aspect, the technology disclosed in this specification pertains to the cooked plant-based meat analog of claim forty-sixth aspect wherein the pulse protein is a crosslinked pulse protein.

In a forty-eighth aspect, the technology disclosed in this specification pertains to the cooked plant plant-based meat analog of the forty-sixth or forty-seventh aspects having a peak compression force when cooked, of between 8,000 g and 12,000 g, or between 8,000 g and 11,500 g or between 8,000 g and 11,000 g or between 8,000 g and 10,500 g or between 8,500 g, and 10,500 g, or between 8,000 g and 10,500 g and, or between 7,500 g and 10,500 g or between 7,000 g and 10,500 g.

In a forty-ninth aspect, the technology disclosed in this specification pertains to the cooked plant plant-based meat analog described in any one of the forty-sixth to forty-eighth aspects having a cohesiveness of the cooked plant-based meat analog of between 0.5 and 0.9, or 0.5 and 0.8, or between 0.5 and 0.7 or between 0.9 and 0.6, or between 0.7 and 0.9.

In a fiftieth aspect, the technology disclosed in this specification pertains to the cooked plant plant-based meat analog described in any one of the forty-sixth to forty-ninth aspects having a resilience of the cooked plant-based meat analog of between 0.2 and 0.5, or between 0.2 and 0.4 or between 0.3 and 0.5 or between 0.3 and 0.4.

In a fifty-first aspect, the technology disclosed in this specification pertains to the cooked plant-based meat analog obtained from the plant-based meat analog or method making a plant-based meat analog as described in any of the first to forty-fifth aspects.

In a fifty-second aspect, the technology disclosed in this specification pertains to a method for making a plant-based meat analog as described in any foregoing claim comprising obtaining a crosslinked pulse protein in process comprising mixing a pulse protein, water and a crosslinking agent selected from the group consisting of transglutaminase and L-cysteine wherein optionally the pulse protein is crosslinked in a solution having pH of from about 4.0 to about 4.5.

In a fifty-third aspect, the technology disclosed in this specification pertains to the method of fifty-second aspect wherein if comprising transglutaminase, the transglutaminase and water are in a ratio (pulse protein and crosslinking agent to water) of about 1:2 and about 1:9, about 1:2 and about 1:7, or between about 1:2 and about 1:6, or between about 1:4 and 1:6, or between about 1:4 and about 1:9 and if comprising L-cysteine, the L-cysteine is mixed pulse protein in a weight ratio (pulse protein composition to L-cysteine) of between about 1:149 and about 1:49, or between about 1:119 and about 1:49, or between about 1:109 and about 1:49, or between about 1:104 and about 1:94.

In a fifty-fourth aspect, the technology disclosed in this specification pertains to the method of the fifty-second or fifty-third aspects, further comprising mixing a structured vegetable oil with the crosslinked pulse protein, wherein the structured vegetable oil comprises with a water-soluble carrier and a vegetable oil wherein optionally the water-soluble carrier is a tapioca maltodextrin.

In a fifty-fifth aspect, the technology disclosed in this specification pertains to the method any one of the fifty-second to fifty-fourth aspects wherein the structure oil has an oil-to-water soluble carrier ratio of greater than 3:1 (oil to carrier), greater than 10:1, or from about 4:1 to about 15:1, or from about 7:1 to about 15:1, or from about 8:1 to about 15:1, or from about 9:1 to about 15:1, or from about 10:1 to about 15:1, or from about 10:1 to about 14:1, or from about 11:1 to about 13:1, or from about 4:1 to about 9:1, or from about 4:1 to about 6:1.

The technology disclosed in this specification is further described by the examples provided below, which are provided for illustrative purposes only and are not limiting in any way.

### EXAMPLE 1—PEA PROTEIN PLANT-BASED MEAT ANALOGS FURTHER COMPRISING A STRUCTURED VEGETABLE OIL

A formula for making a plant-based meat analog using a structured vegetable oil is described in Table 1. Variations of this formula were made without using a protein crosslinking agent, but modification to the formula can be made to incorporate a protein crosslinking agent as described in this specification. Also, variations of this formula were made using a crumbled extruded pulse composition (available from Ingredion Incorporated), and a hydrocolloid mix of carrageenan and locust bean gum, and an unextruded pea protein concentrate (available from Ingredion Incorporated).

TABLE 1
Plant-based meat analog formula

| Ingredient | Wt % |
|---|---|
| Extruded Pulse Crumble | 19.80 |
| Water | 56.41 |
| Methylcellulose Powder | 2.00 |
| Gum mix | 1.50 |
| Tapioca Maltodextrin | 1.00 |
| Modified Starch | 1.50 |
| Pea Protein Concentrate | 1.90 |
| Coconut Oil | 7.00 |
| Sunflower Oil | 5.00 |
| Spices | 1.50 |
| Salt | 0.75 |
| Yeast Extract | 1.00 |
| Coloring | 0.64 |

A plant-based meat analog was prepared using the formulation of Table 1 as follows. Spices, salt and, colorings were added to the water to form a mixture. This mixture was used to hydrate extruded pulse crumble. Separately, sunflower oil (a vegetable oil) and tapioca maltodextrin were mixed to provide a structured vegetable oil. The structured vegetable oil, hydrated crumble, coconut oil and remaining dry ingredients were mixed until a cohesive dough was formed. Patties were formed from the cohesive dough and frozen.

Frozen patties were grilled or baked (350° F./176° C.) for about 8 minutes per side or until internal temperature of 165° F./84° C. was reached. When eaten, it was observed that the cooked plant-based meat alternative delivered a fatty mouthfeel and provided a lubricity greater than that delivered by the liquid oil. It was also observed that during cooking, that the patties provided a controlled release of the liquid oil similar to that which provides a “sizzling” sound like when fat is released by animal-based meat products during cooking. This indicates that while structured vegetable oil was released during cooking to mimic the behavior of cooking meat, and that the patties retained sufficient oil to provide the fatty mouthfeel and lubricity associated with cooked meat.

### EXAMPLE 2—CROSSLINKED FAVA BEAN PROTEIN PLANT-BASED MEAT Analogs

Crosslinked fava bean protein plant-based meat analogs were made from using powdered fava bean protein compositions (65% protein content) in two-phase systems wherein the fava bean protein is dispersed in water (a liquid based system), and in single phase systems wherein the water is absorbed by the powdered fava bean protein composition (a dough-based system).

### EXAMPLE 2A—DOUGH BASED SYSTEM (SINGLE PHASE) SYSTEM

Four dough-based plant-based meat analogs were made using a fava bean protein concentrate and varying crosslinkers. All samples were made using the same method: mix fava bean protein concentrate (available from Ingredion Incorporated), optionally transglutaminase, optionally add L-cysteine, and water in a stand mixer until a cohesive dough formed. The dough rested at room temperature for one hour, was then rolled out into a sheet having a height of about 1.25 cm (about 0.5 inches) and cut into pieces whose length and width provided pieces sized about 1.25 cm² (about 0.5 sq·in). The dough pieces were cooked in a boiling bath for about 15 minutes and allowed to cool to room temperature prior to texture analysis.

SAMPLE 1 was made using 20 g fava bean protein concentrate, 2 g transglutaminase and between 10 g and 15 g water.

SAMPLE 2 was made using 20 g fava bean protein concentrate, 2 g transglutaminase, 0.2 g L-cysteine, and between 10 g and 15 g water.

SAMPLE 3 was made using 20 g fava bean protein concentrate, 0.2 g L-cysteine, and between 10 g and 15 g water.

SAMPLE 4 was made using 20 g fava bean protein concentrate and between 10 g and 15 g water.

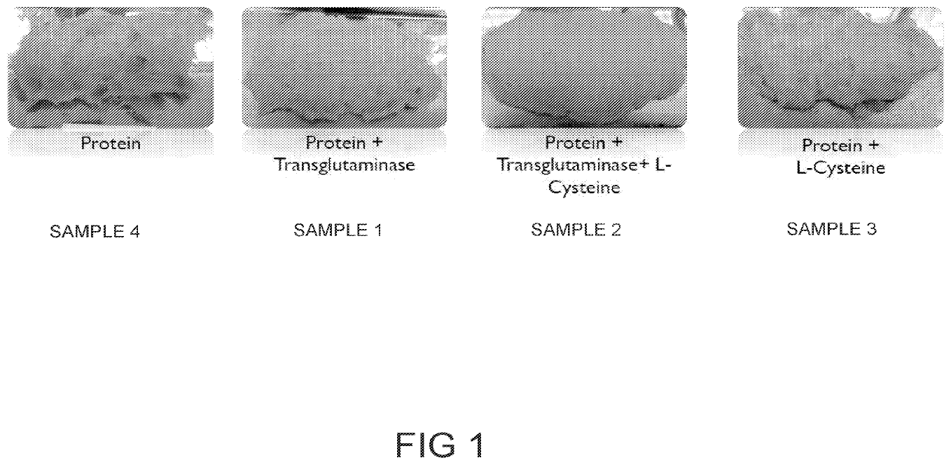

FIG. 1 depicts the textural appearance of the uncooked dough of Samples 1 through 4. Sample 4 provided a less firm, stickier plant-based meat analog as shown by the irregular outer surface interrupted with pockmarks of irregular size and placement. Samples 1 and 3 provided firmer, less sticky plant-based meat analogs having as seen by the smoother outer surfaces than Sample 4 and smaller pockmarks than in Sample 4. Sample 2 provided a the firmest and least sticky plant-based meat analog as seen by its smooth and regular outer surface, and a cohesive shape, when compared to the other Samples.

### EXAMPLE 2B—LIQUID BASED (TWO PHASE) SYSTEM

A plant-based meat analog was made using an alternative process using sufficient liquid to suspend the powdered fava bean protein.

Meat alternatives using the liquid based system were made as follows. Combine 10 parts plant protein concentrate and 50 parts water in a beaker. Mix the contents at room temperature for 1 hour. Transfer the mixture into centrifuge tubes and centrifuge at 3000 g for 10 min. Decant the supernatant into a beaker. Add transglutaminase enzyme by weight to the supernatant and stir for 1 hour after which the solution's pH is adjusted to 5.1 with 1M HCl to precipitated crosslinked fava bean protein. Stir for 10 minutes and and centrifuge at 4000 g for 15 minutes to recover precipitated protein cake. The protein cake was formed into samples and was cooked in boiling water bath for 15 minutes.

Soluble protein content of the powdered fava bean protein was measured to be 75% by weight.

### EXAMPLE 2C—TEXTURE ANALYSIS

Cooked samples of compositions comprising fava bean protein concentrate and transglutaminase were analyzed for peak compression force, cohesiveness, and resilience using a texture analyzer. The cooked samples obtained by the dough-based and liquid-based processes were subjected to texture analysis. The cooked samples were subjected to texture analysis when cooled to room temperature (fresh) or after chilled to 4° C. (refrigerated).

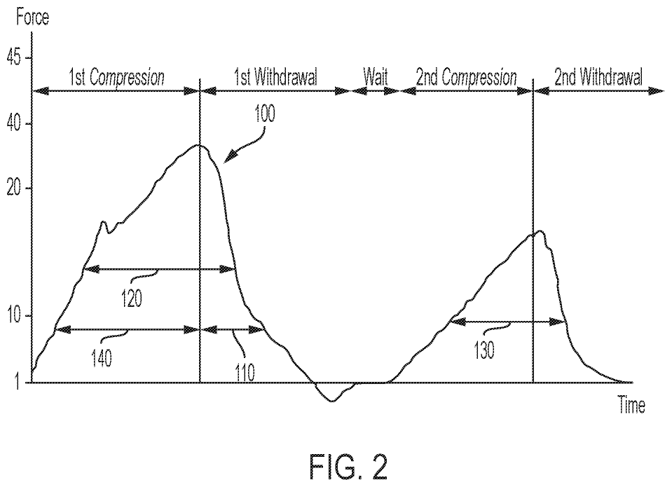

The Texture Profile Analysis (TPA) of a plant-based meat analog was determined using a TAXT Plus texture analyzer. The samples were subjected to two cycles of compression by and withdrawal of a probe. Each sample was compressed twice to 60% of its original height using a circle probe at a moving speed of 5 mm/sec. In any embodiment, a texture analyzer reports one or more of a peak compression force, work of adhesiveness, cohesiveness, and resilience. FIG. 2 presents a typical graph from the two-cycle TPA test of a plant-based meat analog sample. With reference to FIG. 2, peak compression force (g, peak force of first compression), marked at 100 in FIG. 2, is the maximum force applied during the first compression of the sample. Work of adhesiveness (g*sec) is a measurement of the amount of force required to pull the probe from the sample surface during the first cycle; it is equal to the negative force-time area under curve 110 in FIG. 2. Cohesiveness is the ratio of force needed to complete a second cycle versus a first cycle, and provides a measurement of how well the composition withstands repeat compressions. The closer this ratio is to 1 the more cohesive the composition is. Cohesiveness is the ratio of work needed to complete a second cycle versus a first cycle, and measures how well the composition withstands repeat compressions. The closer the ratio is to 1 the more cohesive the composition is. With reference to FIG. 2, cohesiveness is the ratio of the area under curve 120 to the area under curve 130. Resilience is the ratio of work needed to compress the sample versus the work needed to retract the probe. It measures the ability of the composition to return to shape after one compression. With reference to FIG. 2, resilience is the ratio of the area under curve 110 to the area under curve 140. Table 2 reports the results of texture analyses performed on compositions comprising fava bean protein concentrate and transglutaminase, made by either the dough-based or liquid-based processes, after being cooked and cooled to room temperature or 4° C. averaged over two cycles.

TABLE 2
Texture Analysis Results

| | | Peak | Cohesiveness | Resilience |
|---|---|---|---|---|
| | | Compression | (unitless | (unitless |
| Samples | | Force (g) | ratio) | ratio) |
| Dough based | Fresh (Room | 10214 | 0.674 | 0.304 |
| system | temperature) | | | |
| | Refrigerated | 9616 | 0.721 | 0.327 |
| | (4° C.) | | | |
| Liquid based | Fresh (Room | 9054 | 0.831 | 0.357 |
| system | temperature) | | | |
| | Refrigerated | 8552 | 0.824 | 0.366 |
| | (4° C.) | | | |

What is claimed:

1. A plant-based meat analog comprising:
a) a pulse protein;
b) a structured vegetable oil comprising a vegetable oil and a water-soluble carrier; and
c) moisture in an amount of from about 40% to about 65% by weight.

2. The plant-based meat analog of claim 1 wherein the pulse protein selected from the group consisting of pea, chickpea, fava bean, lentil and mixtures thereof.

3. The plant-based meat analog of claim 1 having a protein in an amount between about 50% and about 90% protein (by weight of the analog).

4. The plant-based meat analog of claim 1 further comprising a starch in an amount of between about 1% and about 20% (by weight of the analog).

5. The plant-based meat analog of claim 1 wherein the pulse protein has a water holding capacity of between about 0.5 and about 1.5 (w/w, protein to water).

6. The plant-based meat analog of claim 1 wherein the water-soluble carrier is a tapioca maltodextrin.

7. The plant-based meat analog of claim 1 wherein the structure oil has an oil-to-water soluble carrier ratio of greater than 3:1 (oil to carrier).

8. The plant-based meat analog of claim 1 wherein the water-soluble carrier is used in an amount of from about 0.1 to about 2% (by weight of the analog).

9. The plant-based meat analog of claim 1 further comprising a protein crosslinking agent;
wherein the protein crosslinking agent is selected from the group consisting of a transglutaminase and L-cysteine and mixtures thereof.

10. A plant-based meat analog comprising:
a) a crosslinked pulse protein and
b) a starch;
wherein the protein is crosslinked using a protein crosslinking agent selected from the group consisting of a transglutaminase and L-cysteine and mixtures thereof.

11. The plant-based meat analog of claim 10 further comprising a structured vegetable comprising a water-soluble carrier and a vegetable oil.

12. The plant-based meat analog of claim 10 comprising transglutaminase in a ratio (protein and crosslinking agent to water) of between about 1:2 and about 1:9.

13. The plant-based meat analog of claim 10 comprising L-cysteine in a weight ratio (pulse protein composition to L-cysteine) of between about 1:149 and about 1:49.

14. The plant-based meat analog of claim 10 having a peak compression force when cooked, of between 8,000 g and 12,000 g.

15. The plant-based meat analog of claim 10 having a cohesiveness of the cooked plant-based meat analog of between 0.5 and 0.9.

16. The plant-based meat analog of claim 10 having a resilience of the cooked plant-based meat analog of between 0.2 and 0.5.

17. A method for making a plant-based meat analog comprising: obtaining a crosslinked pulse protein in process comprising mixing a pulse protein, water, and a crosslinking agent selected from the group consisting of transglutaminase and L-cysteine
wherein the pulse protein is crosslinked in a solution having pH of from about 4.0 to about 4.5.

18. The method of claim 17 wherein:
a. if comprising transglutaminase, the transglutaminase and water are in a ratio (pulse protein and crosslinking agent to water) of about 1:2 and about 1:9
b. if comprising L-cysteine, the L-cysteine is mixed pulse protein in a weight ratio (pulse protein composition to L-cysteine) of between about 1:149 and about 1:49.

19. The method of claim 17 further comprising mixing a structured vegetable oil with the crosslinked pulse protein, wherein the structured vegetable oil comprises with a water-soluble carrier and a vegetable oil wherein the water-soluble carrier is a tapioca maltodextrin.

20. The method of any one of claim 17 wherein the structure oil has an oil-to-water soluble carrier ratio of greater than 3:1 (oil to carrier).
